(19) United States
(12) Patent Application Publication
(10) Pub. No.: US 2025/0197615 A1
(43) Pub. Date: Jun. 19, 2025

(54) RUBBER COMPOSITION COMPRISING AN EPOXY RESIN AND A HARDENER

(71) Applicant: COMPAGNIE GENERALE DES ETABLISSEMENTS MICHELIN, Clermont-Ferrand (FR)

(72) Inventors: FABIEN BONNETTE, Clermont-Ferrand (FR); SEVERINE BIZET, Clermont-Ferrand (FR); MARINE BONNEVIDE, Clermont-Ferrand (FR); EMMANUEL LANDREAU, Clermont-Ferrand (FR)

(21) Appl. No.: 18/846,926

(22) PCT Filed: Mar. 9, 2023
(86) PCT No.: PCT/EP2023/055990

§ 371 Date: Sep. 13, 2024

(30) Foreign Application Priority Data
Mar. 15, 2022 (FR) 2202256

(51) Int. Cl. C08L 9/00; B60C 1/00; C08L 7/00

(52) U.S. Cl. CPC C08L 9/00; B60C 1/0016; C08L 7/00; B60C 2001/0091; C08L 2312/00

(57) ABSTRACT

A rubber composition is based on at least one diene elastomer, a reinforcing filler and a crosslinking system, and comprises an epoxy resin selected from tri(glycidoxyphenyl)methane epoxy resins and tetra(glycidoxyphenyl)ethane epoxy resins and mixtures thereof, and a hardener.

### TECHNICAL FIELD OF THE INVENTION

The present invention relates to rubber compositions intended in particular for the manufacture of tyres or of semi-finished products for tyres. Another subject of the present invention is a finished or semi-finished rubber article comprising a rubber composition according to the invention, and also a pneumatic or non-pneumatic tyre comprising at least one composition according to the invention.

### PRIOR ART

It is known to use, in certain parts of tires, rubber compositions exhibiting high stiffness during slight deformations of the tire, as presented in application wo 02/10269. Resistance to small strains is one of the properties which a pneumatic tyre has to exhibit in order to respond to the stresses to which it is subjected.

This stiffening can be obtained by increasing the content of reinforcing filler or by incorporating certain reinforcing resins in the constituent rubber compositions of the parts of the pneumatic tyre.

The reinforcing resins conventionally used to increase the stiffness of the compositions are reinforcing resins based on a methylene acceptor/donor system. The terms “methylene acceptor” and “methylene donor” are well known to a person skilled in the art and are widely used to designate compounds capable of reacting together to generate by condensation a three-dimensional reinforcing resin which is superimposed, interpenetrate with the reinforcing filler/elastomer network on the one hand and with the elastomer/sulfur network on the other hand (if the crosslinking agent is sulfur). Conventionally, the methylene acceptor is a phenolic resin. Phenolic novolac resins have already been described in rubber compositions, in particular intended for pneumatic tyres or treads of pneumatic tyres, for applications as varied as grip or reinforcement: reference will be made, for example, to patent EP 0 649 446.

The methylene acceptor described above is combined with a curing agent, capable of crosslinking or hardening it, also commonly known as “methylene donor” or simply “hardener”. Crosslinking of the resin is then brought about, during the curing of the rubber matrix, by formation of methylene bridges between the carbons in the ortho and para positions of the phenolic nuclei of the resin and the methylene donor, thus creating a three-dimensional resin network.

By way of example, application WO 2011/045342 describes compositions comprising an epoxy resin pair with an amine-comprising hardener. These compositions, in addition to the advantage of being freed from the formation of formaldehyde, exhibit, after crosslinking, greater stiffnesses than conventional compositions while retaining an acceptable rolling resistance. Application WO 2018/002538 describes compositions comprising an epoxy resin and an amine-comprising hardener comprising at least two primary amine functions located on at least one six-membered aromatic ring which are targeted at improving the compromise between processability, in particular the scorch time, and stiffness in comparison with the known compositions. These documents show that the rubber properties are dependent on the constituents used and are difficult to predict.

It is always desirable to further improve the properties of rubber compositions, and in particular the compromise between stiffness at low deformations and hysteresis losses.

Unexpectedly, the applicant has discovered during its research that the combination of an epoxy resin of particular structure and a hardener makes it possible to improve the stiffness at low deformations and the hysteresis losses of a rubber composition.

### DETAILED DESCRIPTION OF THE INVENTION

The invention relates to a rubber composition based on at least:
one diene elastomer;
a reinforcing filler;
a crosslinking system;
between 1 and 30 phr of an epoxy resin selected from tri(glycidoxyphenyl)methane epoxy resins, tetra(glycidoxyphenyl)ethane epoxy resins, and mixtures thereof.
from 0.5 to 15 phr of a hardener.

The invention also relates to a finished or semi-finished rubber article comprising such a composition and to a pneumatic or non-pneumatic tyre comprising such a composition.

### Definitions

For the purposes of the present invention, the expression “part by weight per hundred parts by weight of elastomer” (or phr) should be understood as meaning the part by weight per hundred parts by weight of elastomer or rubber.

In the present document, unless expressly indicated otherwise, all the percentages (%) indicated are percentages (%) by weight.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The expression “composition based on” should be understood as meaning a composition comprising the mixture and/or the product of the in situ reaction of the various constituents used, some of these constituents being able to react and/or being intended to react with each other, at least partially, during the various phases of manufacture of the composition; it thus being possible for the composition to be in the completely or partially crosslinked state or in the non-crosslinked state.

When reference is made to a “predominant” compound, this means, for the purposes of the present invention, that this compound is predominant among the compounds of the same type in the composition, that is to say that it is the one which represents the greatest amount by mass among the compounds of the same type. Thus, for example, a predominant elastomer is the elastomer representing the greatest mass relative to the total mass of the elastomers in the composition. In the same way, a “predominant” filler is that representing the greatest mass among the fillers of the composition. By way of example, in a system comprising only one elastomer, the latter is predominant for the purposes of the present invention, and in a system comprising two elastomers, the predominant elastomer represents more than half of the mass of the elastomers. In contrast, a “minor” compound is a compound which does not represent the greatest fraction by mass among the compounds of the same type. Preferably, the term “predominant” means present to more than 50%, preferably more than 60%, 70%, 80%, 90%, and more preferentially the “predominant” compound represents 100%.

The carbon-comprising compounds mentioned in the description can be of fossil origin or be biobased. In the latter case, they may be partially or completely derived from biomass or obtained from renewable raw materials derived from biomass. In the same way, the compounds mentioned can also originate from the recycling of pre-used materials, that is to say that they can, partially or completely, result from a recycling process, or else be obtained from starting materials themselves resulting from a recycling process. Polymers, plasticizers, fillers, and the like, are concerned in particular.

### Diene Elastomer

The composition according to the invention comprises at least one diene elastomer. It can thus contain just one diene elastomer or a mixture of several diene elastomers.

“Diene” elastomer (or, without distinction, rubber), whether natural or synthetic, is given to mean, as is known, an elastomer at least partially composed (i.e. a homopolymer or a copolymer) of diene monomer units (monomers bearing two conjugated or non-conjugated carbon-carbon double bonds).

These diene elastomers can be classified into two categories: “essentially unsaturated” or “essentially saturated”. The term “essentially unsaturated” is understood to mean generally a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and can in particular be described as “essentially saturated” diene elastomers (low or very low content, always less than 15%, of units of diene origin). The diene elastomers included in the composition according to the invention are preferentially essentially unsaturated.

The term “diene elastomer capable of being used in the compositions in accordance with the invention” is understood in particular to mean:
(a) any homopolymer of a conjugated or non-conjugated diene monomer having from 4 to 18 carbon atoms;
b) any copolymer of a conjugated or non-conjugated diene having from 4 to 18 carbon atoms and of at least one other monomer.

The other monomer can be ethylene, an olefin or a conjugated or non-conjugated diene.

Suitable as conjugated dienes are conjugated dienes having from 4 to 12 carbon atoms, especially 1,3-dienes, such as, in particular, 1,3-butadiene and isoprene.

Suitable as olefins are vinylaromatic compounds having from 8 to 20 carbon atoms and aliphatic α-monoolefins having from 3 to 12 carbon atoms.

Suitable as vinylaromatic compounds are, for example, styrene, ortho-, meta- or para-methylstyrene, the “vinyltoluene” commercial mixture or para-(tert-butyl) styrene.

Suitable as aliphatic α-monoolefins are in particular acyclic aliphatic α-monoolefins having from 3 to 18 carbon atoms.

Preferentially, the diene elastomer is selected from the group consisting of polybutadienes (BRs), natural rubber (NR), synthetic polyisoprenes (IRs), butadiene copolymers, isoprene copolymers and the mixtures of these elastomers. The butadiene copolymers are particularly selected from the group consisting of butadiene/styrene copolymers (SBRs).

Preferably, the diene elastomer is an isoprene elastomer.

The term “isoprene elastomer” means, in a known manner, an isoprene homopolymer or copolymer, in other words a diene elastomer selected from the group consisting of natural rubber (NR), synthetic polyisoprenes (IRs), the various isoprene copolymers, and mixtures of these elastomers. Mention will in particular be made, among the isoprene copolymers, of isobutene/isoprene (butyl rubber—IIR), isoprene/styrene (SIR), isoprene/butadiene (BIR) or isoprene/butadiene/styrene (SBIR) copolymers. This isoprene elastomer is preferably selected from the group consisting of natural rubber, synthetic cis-1,4-polyisoprenes and mixtures thereof use is preferably made, among these synthetic polyisoprenes, of polyisoprenes having a content (mol %) of cis-1,4-bonds of greater than 90%, more preferentially still of greater than 98%. Preferably and according to any one of the arrangements of the present document, the diene elastomer is natural rubber.

Preferentially, the content of diene elastomer, preferably of isoprene elastomer, preferably natural rubber, is from 50 to 100 phr, more preferentially from 60 to 100 phr, in a more preferential way from 70 to 100 phr, more preferentially still from 80 to 100 phr and very preferentially from 90 to 100 phr. In particular, the content of diene elastomer, preferably of isoprene elastomer, more preferably of natural rubber, is very preferentially 100 phr.

Whether it contains just one diene elastomer or a mixture of several diene elastomers, the rubber composition according to the invention can also contain, in a minor way, any type of synthetic elastomer other than a diene elastomer, indeed even polymers other than elastomers, for example thermoplastic polymers. Preferably, the rubber composition according to the invention does not contain a synthetic elastomer other than a diene elastomer or a polymer other than elastomers or contains less than 10 phr, preferably less than 5 phr, thereof.

### Epoxy Resin

The rubber composition according to the invention comprises an epoxy resin selected from tri(glycidoxyphenyl)methane epoxy resins, tetra(glycidoxyphenyl)ethane epoxy resins, and mixtures thereof.

The expression “tri(glycidoxyphenyl)methane epoxy resin and tetra(glycidoxyphenyl)ethane epoxy resin” is understood to mean resins based on tri(glycidoxyphenyl)methane and tetra(glycidoxyphenyl)ethane units, that is to say comprising these constituents, or oligomers of these constituents.

Epoxy resin is a curing resin. The term “curing resin” is understood to mean a resin which, when incorporated into a rubber composition with a curing agent, makes it possible to increase the stiffness of the rubber composition. As it happens, the increase in stiffness of a rubber composition generally goes hand in hand with an increase in hysteresis losses.

The applicant has discovered that, surprisingly, the particular structure of these resins makes it possible to improve the stiffness/hysteresis compromise with respect to other epoxy resins used as an additive in rubber compositions.

The resins used in the context of the invention are preferentially selected from the epoxy resins having the following generic formulae (I) and (II) and derivatives thereof, that is to say oligomers of the compounds of generic formulae (I) and (II):

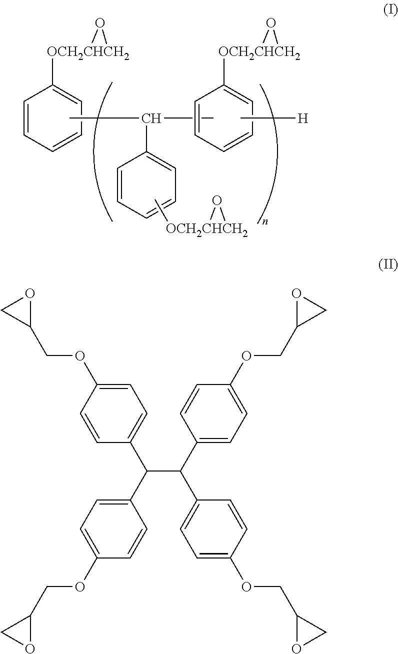

n being an integer expressing the degree of polymerization, n ranging from 1 to 15, preferentially from 1 to 10, more preferentially from 1 to 5 and very preferentially from 1 to 3. As examples of such commercially available resins, mention may be made of the resins “EPPN-502H”, “EPPN-501H” and “EPPN-501HY” from Nippon Kayaku, or the resin “EPON 1031” from Hexion.

Preferably, the composition according to the invention does not comprise curing resins other than an epoxy resin selected from tri(glycidoxyphenyl)methane epoxy resins and tetra(glycidoxyphenyl)ethane epoxy resins, and mixtures thereof.

The composition according to the invention comprises between 1 and 30 phr of epoxy resin, preferentially from 10 to 25 phr of epoxy resin. These contents make it possible to ensure sufficient stiffness of the rubber composition while allowing the latter to retain an elastic-type behavior once crosslinked.

### Hardener

The rubber composition comprises from 0.5 to 15 phr of a hardener. Any hardener capable of crosslinking the epoxy resin used in the rubber compositions according to the invention may be suitable as a hardener. In particular, the hardener may be selected from aromatic diamines, aliphatic diamines, anhydride such as, for example, benzoic anhydride or maleic anhydride, and ureas.

Ureas are compounds of general formula (R₁, R₂)N—CO—N(R₃, R₄) in which the radicals R₁, R₂, R₃ and R₄ are selected independently from the group consisting of:
a hydrogen atom,
an alkyl radical having from 1 to 20 carbon atoms,
a cycloalkyl radical having from 5 to 24 carbon atoms,
an aryl radical having from 6 to 30 carbon atoms and
an aralkyl radical having from 7 to 25 carbon atoms,

The radicals R₂ and R₃ can together form a ring, each radical R₁, R₂, R₃ and R₄ being optionally interrupted with one or more heteroatoms and/or substituted.

In the general formula (R₁, R₂)N—CO—N(R₃, R₄), it is understood that the group CO represents a carbon atom bonded via a double bond to an oxygen atom, and that the group (R₁, R₂) N (respectively N(R₃, R₄)) represents a nitrogen atom bonded to a group R₁ and to a group R₂ via a covalent bond. Such a molecule is shown below.

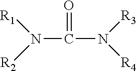

Preferably, the hardener is selected from aromatic diamines and ureas. These families of hardeners in fact exhibit a speed of crosslinking during curing/stiffness of the crosslinked product balance which is particularly advantageous for the compositions according to the invention.

Very preferentially, according to the invention, the aromatic diamine-comprising hardener is selected from the group consisting of the compounds below and the mixtures of these compounds:

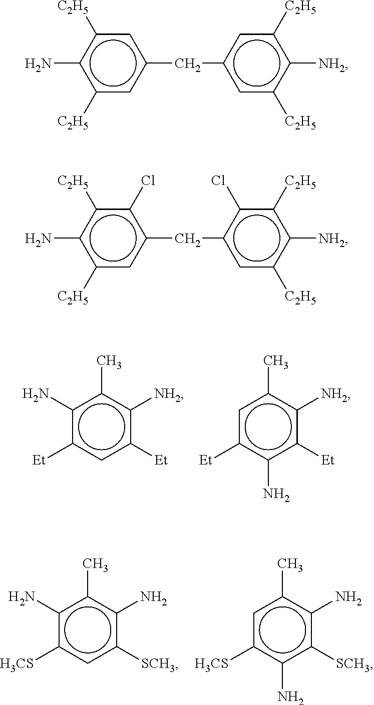

Mention may be made, as example of commercially available amine-comprising hardeners which can be used in the context of the present invention, for example, of Ethacure 100 or Ethacure 300 from Albemarle or Lonzacure DETDA, Lonzacure MDEA or Lonzacure MCDEA from Lonza.

Very preferentially, according to the invention, the ureas are selected from carbamide, N,N′-dimethylurea, ethyleneurea, N-phenylurea and 1,3-diphenylurea compounds, preferably selected from urea, N,N′-dimethylurea, N-phenylurea and 1,3-diphenylurea compounds and very preferably selected from carbamide N,N′-dimethylurea compounds and very preferentially are carbamide, also called urea, of formula H₂N—CO—NH₂.

Preferably, the ureas do not comprise an aromatic ring.

Preferably, each radical R₁, R₂, R₃ and R₄ is a hydrogen atom. The compound of formula H₂N—CO—NH₂ is commonly referred to as “urea” ou “carbamide”.

Preferably, the hardener is selected from dimethylthiotoluenediamine, carbamide and N,N′-dimethylurea compounds, preferentially from dimethylthiotoluenediamine and carbamide compounds.

The amount of hardener in the rubber composition is within a range extending from 0.5 to 15 phr. Below the minimum indicated, the targeted technical effect has proved to be insufficient whereas, above the maximum indicated, risks arise of the processing in the raw state of the compositions being disadvantaged. Preferentially, the content of hardener is within a range extending from 0.5 to 10 phr, preferably within a range extending from 0.5 to 8 phr.

### Reinforcing Filler

The composition according to the invention comprises a reinforcing filler.

The reinforcing filler can comprise any type of reinforcing filler known for its abilities to reinforce a rubber composition which can be used for the manufacture of pneumatic tyres, for example an organic filler, such as carbon black, a reinforcing inorganic filler, such as silica, or a mixture of carbon black and of reinforcing inorganic filler. More preferentially, the reinforcing filler predominantly, very preferentially exclusively, comprises carbon black, in particular in the case where the composition is used in an internal layer. The reinforcing filler can also predominantly comprise a reinforcing inorganic filler, in particular in the case where the composition is used in a tread.

Such a reinforcing filler typically consists of particles, the (weight-) average size of which is less than a micrometre, generally less than 500 nm, most often between 20 and 200 nm, in particular and more preferentially between 20 and 150 nm.

All carbon blacks, in particular blacks of the HAF, ISAF or SAF type, conventionally used in pneumatic tyres (“tyre-grade” blacks), are suitable as carbon blacks. Among the latter, mention will more particularly be made of the reinforcing carbon blacks of the 100, 200 or 300 series (ASTM grades), such as, for example, the N115, N134, N234, N326, N330, N339, N347 or N375 blacks, or also, depending on the applications targeted, blacks of higher series (for example N660, N683 or N772). The carbon blacks might, for example, be already incorporated in an isoprene elastomer in the form of a masterbatch (see, for example, applications WO 97/36724 and WO 99/16600). The BET specific surface of the carbon blacks is measured according to standard D6556-10 [multipoint (a minimum of 5 points) method—gas: nitrogen—relative pressure p/p₀ range: 0.1 to 0.3].

The term “reinforcing inorganic filler” should be understood, in the present patent application, as meaning, by definition, any inorganic or mineral filler, whatever its colour and its origin (natural or synthetic), also referred to as “white filler”. “clear filler”, indeed even “non-black filler”, in contrast to carbon black, capable of reinforcing, by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET specific surface area and also a CTAB specific surface area which are both less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface as described in application WO 03/16837.

The BET specific surface area of the silica is determined in a known way by gas adsorption using the Brunauer-Emmett-Teller method described in “The Journal of the American Chemical Society”, vol. 60, page 309, February 1938, more specifically according to the French standard NF ISO 9277 of December 1996 (multipoint (5 point) volumetric method—gas: nitrogen—degassing: 1 hour at 160° C.—relative pressure p/p₀ range: 0.05 to 0.17). The CTAB specific surface area of the silica is determined according to the French standard NF T 45-007 of November 1987 (method B).

Mineral fillers of the aluminous type, in particular alumina (Al₂O₃) or aluminium (oxide) hydroxides, or else reinforcing titanium oxides, for example described in U.S. Pat. Nos. 6,610,261 and 6,747,087, are also suitable as reinforcing inorganic fillers.

The physical state in which the reinforcing inorganic filler is provided is not important, whether it is in the form of a powder, microbeads, granules, beads or any other suitable densified form. Of course, the term “reinforcing inorganic filler” is also understood to mean mixtures of different reinforcing inorganic fillers, in particular of highly dispersible siliceous and/or aluminous fillers.

A person skilled in the art will understand that use might be made, as filler equivalent to the reinforcing inorganic filler described in the present section, of a reinforcing filler of another nature, in particular organic nature, provided that this reinforcing filler is covered with an inorganic layer, such as silica, or else comprises, at its surface, functional sites, in particular hydroxyl sites, making it possible to establish the bond between the filler and the elastomer in the presence or absence of a covering or coupling agent.

In order to couple the reinforcing inorganic filler to the diene elastomer, use may be made, in a well-known manner, of an at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound can comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of (symmetrical or asymmetrical) organosilane polysulfides, such as bis(3-triethoxysilylpropyl) tetrasulfide, abbreviated to TESPT, sold under the name Si69 by Evonik, or bis(3-triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl) propyl) octanethioate, sold by Momentive under the name NXT Silane. More preferentially, the organosilane is an organosilane polysulfide.

The content of coupling agent is preferentially less than 12 phr, it being understood that it is generally desirable to use as little as possible of it. Typically, when a reinforcing inorganic filler is present, the content of coupling agent represents from 0.5% to 15% by weight, relative to the amount of inorganic filler. Its content is preferentially within a range extending from 0.5 to 15 phr. This content is easily adjusted by a person skilled in the art according to the content of inorganic filler used in the composition.

According to the invention, when the reinforcing filler is present, the content of reinforcing filler, the reinforcing filler preferably predominantly, indeed even exclusively, comprising carbon black, can be within a range extending from 20 to 200 phr, preferably from 30 to 150 phr, preferably from 40 to 100 phr, preferably from 50 to 80 phr.

### Crosslinking System

The crosslinking system can be any type of system known to a person skilled in the art in the field of rubber compositions for pneumatic tyres. It can in particular be based on sulfur and/or on peroxide and/or on bismaleimides.

The crosslinking system is preferentially based on sulfur. This is then referred to as a vulcanization system. The sulfur can be contributed in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or equivalent compound, such as stearic acid salts, and salts of transition metals, guanidine derivatives (in particular diphenylguanidine), or also known vulcanization retarders.

Sulfur is used in a preferential content of between 0.5 and 12 phr, in particular between 1 and 10 phr. The vulcanization accelerator is used in a preferential content of between 0.5 and 10 phr, more preferentially between 0.5 and 8.0 phr.

Use may be made, as accelerator, of any compound capable of acting as accelerator of the vulcanization of diene elastomers in the presence of sulfur, in particular accelerators of the thiazole type, and also derivatives thereof, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and the mixtures of these compounds.

### Various Additives

The rubber compositions in accordance with the invention can also comprise all or part of the usual additives and processing aids known to a person skilled in the art and generally used in rubber compositions for pneumatic tyres, such as, for example, plasticizers (such as plasticizing oils and/or plasticizing resins), pigments, protective agents, such as antiozone waxes, chemical antiozonants or antioxidants, or anti-fatigue agents.

Preferably, the composition according to the invention does not comprise nitrile compounds or comprises less than 10 phr, preferably less than 5 phr, in a preferred way less than 2 phr, very preferably less than 1 phr and more preferentially still less than 0.5 phr thereof.

The composition can be either in the raw state (before crosslinking or vulcanization) or in the cured state (after crosslinking or vulcanization).

### Finished or Semi-Finished Rubber Article and Pneumatic Tyre

Another subject of the present invention is a finished or semi-finished rubber article comprising a composition according to the invention. The term “semi-finished article” is understood to mean an article intended to be used as a component for the construction of a finished article.

A subject of the present invention is also a pneumatic tyre which comprises a composition according to the invention.

It is possible to define, within the pneumatic tyre, three types of regions:
The radially exterior region in contact with the ambient air, comprising the layers referred to as “external layers”, these layers essentially comprising the tread and the external sidewall of the pneumatic tyre. An outer sidewall is an elastomeric layer positioned outside the carcass reinforcement with respect to the internal cavity of the pneumatic tyre, between the crown and the bead, so as to completely or partially cover the region of the carcass reinforcement extending from the crown to the bead.
The radially interior region in contact with the inflation gas, this region generally being composed of the layer airtight to the inflation gases, sometimes referred to as interior airtight layer or inner liner.
The internal region of the pneumatic tyre, that is to say that between the exterior and interior regions. This region includes layers or plies which are referred to here as internal layers of the pneumatic tyre. These are, for example, carcass plies, tread underlayers, pneumatic tyre belt plies or any other layer which is not in contact with the ambient air or the inflation gas of the pneumatic tyre.

The composition defined in the present description is particularly well suited to the inner and outer layers of pneumatic tyres, and in particular, for the outer layers, to tread compositions.

According to the invention, the internal layer can be selected from the group consisting of carcass plies, crown plies, bead-wire fillings, crown feet, decoupling layers, edge rubbers, padding rubbers, the tread underlayer and the combinations of these internal layers. Preferably, the internal layer is selected from the group consisting of carcass plies, crown plies, bead-wire fillings, crown feet, decoupling layers and the combinations of these internal layers.

The composition according to the invention may also be suitable for the internal and external layers of non-pneumatic tyres, in particular for the treads of non-pneumatic tyres. It should be remembered that a non-pneumatic tyre is a tyre which supports the load of a vehicle by a means other than a pressurized inflation gas, for example by means of semi-rigid stays.

The invention relates in particular to tyres intended to equip motor vehicles of passenger vehicle type. SUVs (Sport Utility Vehicles), or two-wheel vehicles (in particular motorcycles), or aircraft, or also industrial vehicles selected from vans, heavy-duty vehicles, that is to say underground trains, buses, heavy road transport vehicles (lorries, tractors, trailers) or off-road vehicles, such as heavy agricultural vehicles or earthmoving equipment, and others.

The invention relates to the articles comprising a rubber composition according to the invention, both in the raw state (that is to say, before curing) and in the cured state (that is to say, after crosslinking or vulcanization).

### Preparation of the Rubber Compositions

The rubber composition in accordance with the invention may be manufactured in appropriate mixers using two successive preparation phases well known to a person skilled in the art:
a first phase of thermomechanical working or kneading (“non-productive” phase), which can be carried out in a single thermomechanical step during which all the necessary constituents, in particular the elastomeric matrix, the fillers and the various other optional additives, with the exception of the crosslinking system, are introduced into an appropriate mixer, such as a standard internal mixer (for example of ‘Banbury’ type). The incorporation of the filler into the elastomer may be performed in one or more portions while thermomechanically kneading. In the case where the filler is already incorporated, totally or partly, into the elastomer in the form of a masterbatch, as is described, for example, in patent applications WO 97/36724 or WO 99/16600, it is the masterbatch which is directly kneaded and, where appropriate, the other elastomers or fillers present in the composition which are not in masterbatch form, and also the optional various other additives, with the exception of the crosslinking system, are incorporated.

The non-productive phase is carried out at high temperature, up to a maximum temperature of between 110° C. and 190° C., preferably between 130° C. and 180° C. for a period of time generally of between 2 and 10 minutes.
a second phase of mechanical working (“productive” phase), which is carried out in an external mixer, such as an open mill, after cooling the mixture obtained during the first non-productive phase down to a lower temperature, typically of less than 110° C. for example between 40° C. and 100° C. The crosslinking system is then incorporated and everything is then mixed for a few minutes, for example between 2 and 15 min.

The process for preparing such compositions comprises, for example, the following steps:
a) incorporating a reinforcing filler in a diene elastomer during a first step (“non-productive” step), everything being kneaded thermomechanically (for example, in one or more goes), until a maximum temperature of between 110° C. and 190° C. is reached;
b) cooling the combined mixture to a temperature of less than 100° C.;
c) subsequently incorporating, during a second step (“productive” step), a crosslinking system;
d) kneading everything up to a maximum temperature of less than 110° C.

Between 1 and 30 phr of the epoxy resin and from 1 to 15 phr of hardener can introduced, independently of one another, either during the non-productive phase (a) or during the productive phase (c). Preferably, the epoxy resin is introduced during the non-productive phase (a), whereas the hardener is introduced during the productive phase (c).

The final composition thus obtained can subsequently be calendered, for example in the form of a sheet or plaque, in particular for laboratory characterization, or also extruded in the form of a rubber semi-finished product (or profiled element) used in the manufacture of a pneumatic tyre.

The crosslinking of the composition can be carried out in a way known to a person skilled in the art, for example at a temperature of between 120° C. and 200° C. under pressure.

### Examples

### Measurements and Tests Used

### Tensile Tests

The tests were carried out in accordance with French standard NF T 46-002 of September 1988. All the tensile measurements were carried out at a temperature representative of the operating temperature of the composition in a tyre (100±2° C.) and under standard hygrometry conditions (50±5% relative humidity), according to French standard NF T 40-101 (December 1979).

The nominal secant modulus calculated by relating back to the initial section of the test piece (or apparent stress, in MPa) at 10% elongation denoted MA10, was measured at second elongation (i.e. after accommodation) on samples cured at t₉₅ at 150° C. The curing time of each sample termed “t₉₅” is the time required to reach 95% of the maximum torque, determined according to standard DIN 53529, with an oscillating chamber rheometer of the MCCS “C” type (parallel type measuring chamber). The change in the rheometric torque as a function of the time describes the change in the stiffening of the composition during crosslinking. An RPA type analyzer can also be used.

### Impact Losses

The rolling resistance induced by the test composition is estimated by measuring the energy losses by measurement, at a temperature of 60° C., of the energy restored at the eighth rebound of a sample on which an initial energy has been imposed, as described in standard DIN 53-512 of April 2000. This measurement is denoted P60 and is calculated as follows: P60(%)=100×(E0−E1)/E0, where E0 represents the initial energy and E1 the returned energy. The lower this value, the less the test sample displays hysteresis losses.

### Preparation of the Compositions

The tests which follow are carried out in the following way: the diene elastomer, the reinforcing filler and the various other ingredients, with the exception of the vulcanization system and of the epoxy resin, are successively introduced into an internal mixer (final degree of filling: approximately 70% by volume), the initial vessel temperature of which is approximately 50° C., followed by the epoxy resin. Thermomechanical working (non-productive phase) is then carried out in one step, which lasts in total approximately from 3 to 4 min, until a maximum “dropping” temperature of 165° C. is reached.

The mixture thus obtained is recovered and cooled and then sulfur, an accelerator of sulfenamide type and the hardener are incorporated on a mixer (homofinisher) at 30° C., everything being mixed (productive phase) for an appropriate time (for example between 5 and 12 min).

The compositions thus obtained are subsequently calendered, either in the form of plaques (thickness of 2 to 3 mm) or of thin sheets of rubber, for the measurement of their physical or mechanical properties, or extruded in the form of a profiled element.

The crosslinking of the composition is carried out at a temperature of 150° C., for a period corresponding to the t95 under pressure.

### Tests on Rubber Compositions

Six rubber compositions were prepared as indicated above. Their formulations (in phr) and their properties have been summarized in Table 1 below.

The compositions presented in this Table 1 do not give rise to the formation of formaldehyde during curing.

TABLE 1

| Constituents (phr) | C1 | C2 | C3 | G4 | CS | C6 |
|---|---|---|---|---|---|---|
| NR (1) | 100.00 | 100.00 | 100.00 | 100.00 | 100.00 | 100.00 |
| Carbon black (2) | 70.00 | 70.00 | 70.00 | 70.00 | 70.00 | 70.00 |
| 6PPD (3) | 2.50 | 2.50 | 2.50 | 2.60 | 2.50 | 2.50 |
| Stearic Acid (4) | 2.00 | 2.00 | 2.00 | 2.00 | 2.00 | 2.00 |
| ZnO (5) | 3.00 | 3.00 | 3.00 | 3.00 | 3.00 | 3.00 |
| CBS (6) | 2.00 | 2.00 | 2.00 | 2.00 | 2.00 | 2.00 |
| Sulfur | 3.00 | 3.00 | 3.00 | 3.00 | 3.00 | 3.00 |
| Hardener (7) | 4.00 | 4.00 | 4.00 | 4.00 | 4.00 | 4.00 |
| Epoxy resin 1 (8) | | 12.00 | | | | |
| Epoxy resin 2 (9) | 12.00 | | | | | |
| Epoxy resin 3 (10) | | | 12.00 | | | |
| Epoxy resin 4 (11) | | | | 12.00 | | |
| Epoxy resin 5 (12) | | | | | 12.00 | |
| Epoxy resin 6 (13) | | | | | | 12.00 |

Properties in the Cured state

| | | | | | | |
|---|---|---|---|---|---|---|
| MA10 @ 100° C. (base 100) | 100 | 72 | 116 | 115 | 123 | 101 |
| Loss on impact 60° C. (Base 100) | 100 | 100 | 94 | 98 | 97 | 94 |

(1) Natural Rubber
(2) Carbon black N326 (name according to standard ASTM D-1765)
(3) N-(1,3-Dimethylbutyl)-N′-phenyl-para-phenylenediamine (Santoflex 6-PPD from Flexsys)
(4) Stearin (Pristerene 4931 from Uniqema)
(5) Zinc oxide (industrial grade - Umicore)
(6) N-Cyclohexylbenzothiazolesulfenamide (Santocure CBS from Flexsys)
(7) Ethacure 300 hardener from Albemarle
(8) Epoxy phenol novolac resin (EPN 1138 from Huntsman)
(9) Araldite 1299 resin from Huntsman
(10) EPPN-502H resin from Nippon Kayaku
(11) EPPN-501H resin from Nippon Kayaku
(12) EPPN-501HY resin from Nippon Kayaku
(13) EPON 1031 resin from Hexion

It is noted that the compositions in accordance with the invention make it possible to obtain lower losses, and therefore lower rolling resistance, while exhibiting a stiffness greater than the control compositions.

1.-14. (canceled)

15. A rubber composition based on at least:
one diene elastomer;
a reinforcing filler;
a crosslinking system;
between 1 and 30 phr of an epoxy resin selected from tetra(glycidoxyphenyl)ethane epoxy resins; and
from 0.5 to 15 phr of a hardener.

16. The rubber composition according to claim 15, wherein the epoxy resin is selected from epoxy resins having the following generic formula and oligomers of the compounds of generic formula (II):

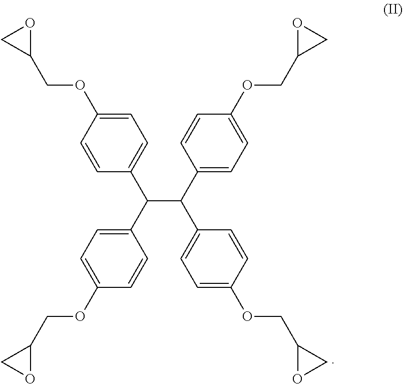 [SMILES: c1cc(C(c2ccc(OCC3CO3)cc2)C(c2ccc(OCC3CO3)cc2)c2ccc(OCC3CO3)cc2)ccc1OCC1CO1]

17. The rubber composition according to claim 15, wherein the rubber composition comprises no curing resins other than the epoxy resin selected from tetra(glycidoxyphenyl)ethane epoxy resins.

18. The rubber composition according to claim 15, wherein the epoxy resin content ranges from 10 to 25 phr.

19. The rubber composition according to claim 15, wherein the hardener is selected from the group consisting of aromatic diamines, aliphatic diamines, anhydride and ureas.

20. The rubber composition according to claim 15, wherein the hardener is selected from the group consisting of aromatic diamines and ureas.

21. The rubber composition according to claim 15, wherein the hardener is an aromatic diamine hardener selected from the group consisting of: 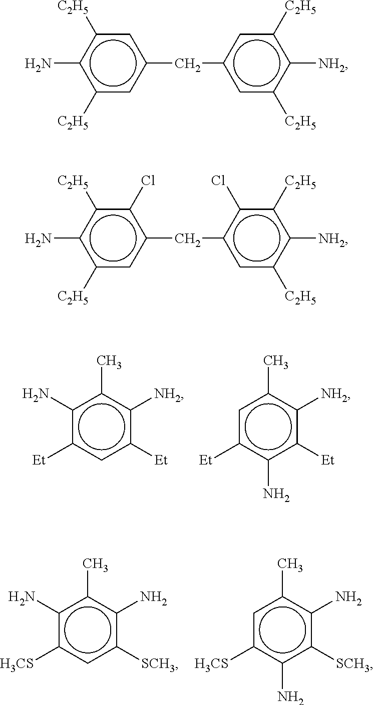
and combinations thereof.

22. The rubber composition according to claim 19, wherein the ureas are selected from the group consisting of carbamide, N,N′-dimethylurea, ethyleneurea, N-phenylurea and 1,3-diphenylurea compounds.

23. The rubber composition according to claim 15, wherein the hardener is selected from the group consisting of dimethylthiotoluenediamine, carbamide and N,N′-dimethylurea compounds.

24. The rubber composition according to claim 15, wherein the amount of hardener in the rubber composition is within a range extending of from 0.5 to 10 phr.

25. The rubber composition according to claim 15, wherein a diene elastomer content is from 50 to 100 phr.

26. The rubber composition according to claim 15, wherein the diene elastomer is an isoprene elastomer.

27. A finished or semi-finished rubber article comprising the rubber composition according to claim 15.

28. A pneumatic or non-pneumatic tire comprising the rubber composition according to claim 15.
